(19) United States
(12) Patent Application Publication
(10) Pub. No.: US 2012/0234020 A1
(43) Pub. Date: Sep. 20, 2012

(54) SYSTEMS AND METHODS FOR ASSEMBLING AN EVAPORATIVE COOLER

(76) Inventors: Przemyslaw Krzysztof Nikolin, Reading (GB); Willam Keith Albert Eyers, Chobham (GB); Peter John Duncan Smith, Basingstoke (GB)

(21) Appl. No.: 13/395,334

(22) PCT Filed: Sep. 10, 2009
(86) PCT No.: PCT/IB09/53969

§ 371 Date: May 24, 2012

(51) Int. Cl. F02C 6/00; F28D 5/00; B23P 11/00

(52) U.S. Cl. 60/801; 29/428; 62/304

(57) ABSTRACT

A method of assembling an evaporative cooler for use with a gas turbine engine system. The method includes coupling a drain pan to a support frame, wherein the drain pan includes a front wall and a back wall. A media support assembly is coupled to the drain pan to form the evaporative cooler. The media support assembly includes a media support wall and a rear flange. The media support wall extends substantially perpendicularly from the drain pan front wall and defines a continuous drainage chamber between the drain pan front wall and the back wall.

### BACKGROUND OF THE INVENTION

The present invention relates generally to inlet air treatment systems, and more specifically, to systems and methods for assembling an evaporative cooler for use in gas turbine engine systems.

At least some known gas turbine engines include a compressor section, a combustor section, and at least one turbine section. The compressor compresses air, that is mixed with fuel and channeled to the combustor. The mixture is then ignited generating hot combustion gases that are then channeled to the turbine. The turbine extracts energy from the combustion gases for powering the compressor, as well as producing useful work to power a load, such as an electrical generator, or to propel an aircraft in flight.

At least some known gas turbine engine systems include inlet air treatment systems that reduce the temperature of air channeled to the compressor, which facilitates increasing the efficiency of the gas turbine engine system. At least some known inlet air filtration systems include an evaporative cooler that reduces the temperature of intake air by channeling intake air through a wetted cooling media. At least some known evaporative coolers channel a cooling fluid through a media and in contact with intake air passing through the media. As the cooling fluid contacts the intake air, heat is transferred from the intake air to the cooling fluid through evaporative cooling. During this process, at least a portion of the cooling fluid evaporates and carries the transferred heat away from the intake air. A drain pan positioned below the cooling media collects the cooling fluid that does not evaporate. As the intake air flows through the cooling media, at least a portion of the cooling fluid is carried by the intake air. In known evaporative coolers, a drift eliminator is used in an attempt to remove the remaining cooling fluid from the intake air before the intake air is channeled to the compressor. Moreover, in at least some known evaporative coolers, a drain pan that includes a segregated cooling media drainage chamber supports the cooling media and the drift eliminator. The segregated cooling media drainage chamber prevents a flow of intake air from bypassing the cooling media by providing a sealed drainage chamber underneath the cooling media. Known drainage pans include a plurality of drain lines that are each coupled to a segregated drainage chamber.

Accordingly, it is desirable to provide a method and/or system to facilitate preventing a flow of intake air from bypassing the cooling media without requiring a drain pan that includes segregated drainage chambers. Moreover, it is desirable to provide a system that facilitates reducing the cost of manufacturing dual drain lines and additional materials required to assemble a drain pan that includes segregated drainage channels.

### BRIEF DESCRIPTION OF THE INVENTION

In one embodiment, a method of assembling an evaporative cooler for use with a turbine engine system is provided. The method includes coupling a drain pan to a support frame, wherein the drain pan includes a front wall and a back wall. A media support assembly is coupled to the drain pan to form the evaporative cooler. The media support assembly includes a media support wall and a rear flange. The media support wall extends substantially perpendicularly from the drain pan front wall and defines a continuous drainage chamber between the drain pan front wall and the back wall.

In another embodiment, an evaporative cooler assembly for use with a turbine engine system is provided. The evaporative cooler assembly includes a drain pan that includes a front wall and a back wall opposite the front wall, and a media support assembly that includes a media support wall and a rear flange. The media support assembly extends substantially perpendicularly from the drain pan front wall such that a continuous drainage chamber is defined between the drain pan front wall and the drain pan back wall.

In yet another embodiment, a gas turbine engine system is provided. The gas turbine engine system includes a compressor, a combustor in flow communication with and downstream from the compressor, and an evaporative cooler assembly coupled to the compressor. The evaporative cooler assembly includes a drain pan that includes a front wall and a back wall, and a media support assembly that includes a media support wall and a rear flange. The media support assembly extends substantially perpendicularly from the front wall such that a continuous drainage chamber is defined between the drain pan front wall and the drain pan back wall.

### BRIEF DESCRIPTION OF THE DRAWINGS

FIG. 1 is a schematic illustration of an exemplary gas turbine engine system;

FIG. 2 is a schematic view of an exemplary inlet air treatment system that includes an evaporative cooler that may be used with the turbine engine shown in FIG. 1;

FIG. 3 is a perspective view of an exemplary evaporative media module that may be used with the evaporative cooler shown in FIG. 2;

FIG. 4 is a partial perspective view of an exemplary media drain assembly that may be used with the evaporative cooler shown in FIG. 2; and

FIG. 5 is a cross-sectional view of the media drain assembly shown in FIG. 4.

### DETAILED DESCRIPTION OF THE INVENTION

The exemplary methods and systems described herein overcome disadvantages of known evaporative coolers by providing a media drain assembly that facilitates improved cooling of a flow of intake air by substantially preventing the air flow from bypassing a cooling media. More specifically, the embodiments described herein channel air flow across a full width of a cooling media by substantially sealing a bypass flowpath defined between a front side and a bottom side of the cooling media. In addition, the embodiments described herein facilitate the assembly of a media drain assembly that includes a continuous drainage chamber, wherein fluid collected from the cooling media and a drift eliminator may be channeled to a common drain.

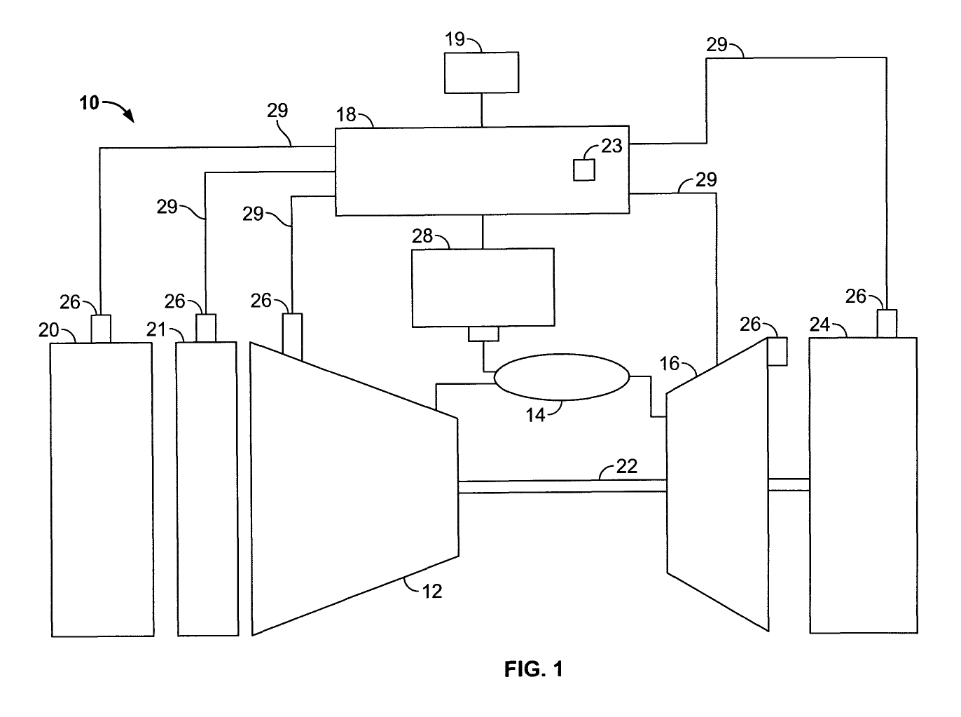

FIG. 1 is a schematic diagram of a gas turbine engine system 10. In the exemplary embodiment, gas turbine engine system 10 includes, coupled in serial relationship, an inlet air treatment system 20 that includes an evaporative cooler 21, a compressor 12, a combustor 14, a turbine 16 rotatably coupled to compressor 12 by a rotor shaft 22, a control system or controller 18, and a fuel control assembly 28. Combustor 14 is coupled to compressor 12 such that combustor 14 is in flow communication with compressor 12. Fuel control assembly 28 is coupled to combustor 14 and channels fuel into combustor 14. Inlet air treatment system 20 channels filtered air to compressor 12. In one embodiment, injected water and/or other humidifying agents are also channeled to compressor 12 through inlet air treatment system 20. Inlet air treatment system 20 may include multiple ducts, filters, screens and/or sound-absorbing devices that may contribute to pressure losses of ambient air flowing through inlet air treatment system 20 into compressor 12.

During operation, inlet air treatment system 20 filters and channels ambient air towards compressor 12, wherein the air is compressed to a higher pressure. Compressor 12 discharges compressed air towards combustor 14 wherein the compressed air is mixed with fuel and ignited to generate combustion gases that flow towards turbine 16. Rotation of turbine 16 drives compressor 12. Combustor 14 channels combustion gases to turbine 16 wherein gas stream thermal energy is converted to mechanical rotational energy. In the exemplary embodiment, gas turbine engine system 10 may be used to drive a load 24, such as a generator, which may be coupled to rotor shaft 22.

The operation of gas turbine engine system 10 is monitored by several sensors 26 that detect various conditions of turbine 16, generator 24, and/or ambient environment. For example, pressure sensors 26 monitor ambient pressure and static and dynamic pressure levels at inlet air treatment system 20 and/or at other locations in the gas stream defined within engine system 10. Temperature sensors 26 also measure ambient air temperature at the inlet air treatment system 20. Sensors 26 may also include flow sensors, speed sensors, flame detector sensors, valve position sensors, guide vane angle sensors, and/or other sensors that sense various parameters relative to the operation of gas turbine engine system 10. As used herein, the term “parameters” refer to physical properties whose values can be used to define the operating conditions of gas turbine engine system 10, such as temperatures, pressures, and gas flows at defined locations.

In the exemplary embodiment, control system 18 communicates with sensors 26 via communication links 29, which may be implemented in hardware and/or software. In one embodiment, communication links 29 remotely communicate data signals to and from control system 18 in accordance with any wired or wireless communication protocol known to one of ordinary skill in the art guided by the teachings herein. Such data signals may include signals indicative of operating conditions of engine system 10 transmitted to the control system 18 and various command signals communicated by control system 18 to sensors 26.

Control system 18 may be a computer system that includes a display 19 and at least one processor 23. As used herein, the term “processor” is not limited to integrated circuits referred to in the art as a computer, but broadly refers to a controller, a microcontroller, a microcomputer, a programmable logic controller (PLC), an application specific integrated circuit, and other programmable circuits, and these terms are used interchangeably herein. It should be understood that a processor and/or control system can also include memory, input channels, and/or output channels. Control system 18 executes programs for use in controlling an operation of gas turbine engine system 10 based on sensor inputs and instructions from human operators. Programs executed by control system 18 may include, for example, calibrating algorithms for calibrating gas sensors 26. User input functionality is provided in display 19. Display 19 acts as a user input selection device and in the exemplary embodiment, display 19 is responsive to the user contacting display 19 to selectively perform functionality. Display 19 may also include a keypad that operates in a conventional well known manner. Thus, the user can operate desired functions available with control system 18 by contacting a surface of display 19. Commands generated by control system 18 cause gas sensors 26 to monitor the ambient environment for the presence of combustible zones, toxic zones, and/or oxygen deficient zones, and to activate other control settings on gas turbine engine system 10.

In the embodiments described herein, memory may include, without limitation, a computer-readable medium, such as a random access memory (RAM), and a computer-readable non-volatile medium, such as a flash memory. Alternatively, a floppy disk, a compact disc-read only memory (CD-ROM), a magneto-optical disk (MOD), and/or a digital versatile disc (DVD) may also be used. Also, in the embodiments described herein, input channels include, without limitation, sensors and/or computer peripherals associated with an operator interface. Further, in the exemplary embodiment, output channels may include, without limitation, a control device, an operator interface monitor and/or a display.

Processors described herein process information transmitted from a plurality of electrical and electronic devices that may include, without limitation, sensors, actuators, compressors, control systems, and/or monitoring devices. Such processors may be physically located in, for example, a control system, a sensor, a monitoring device, a desktop computer, a laptop computer, a programmable logic controller (PLC) cabinet, and/or a distributed control system (DCS) cabinet. RAM and storage devices store and transfer information and instructions to be executed by the processor(s). RAM and storage devices can also be used to store and provide temporary variables, static (i.e., non-changing) information and instructions, or other intermediate information to the processors during execution of instructions by the processor(s). The execution of sequences of instructions is not limited to any specific combination of hardware circuitry and software instructions

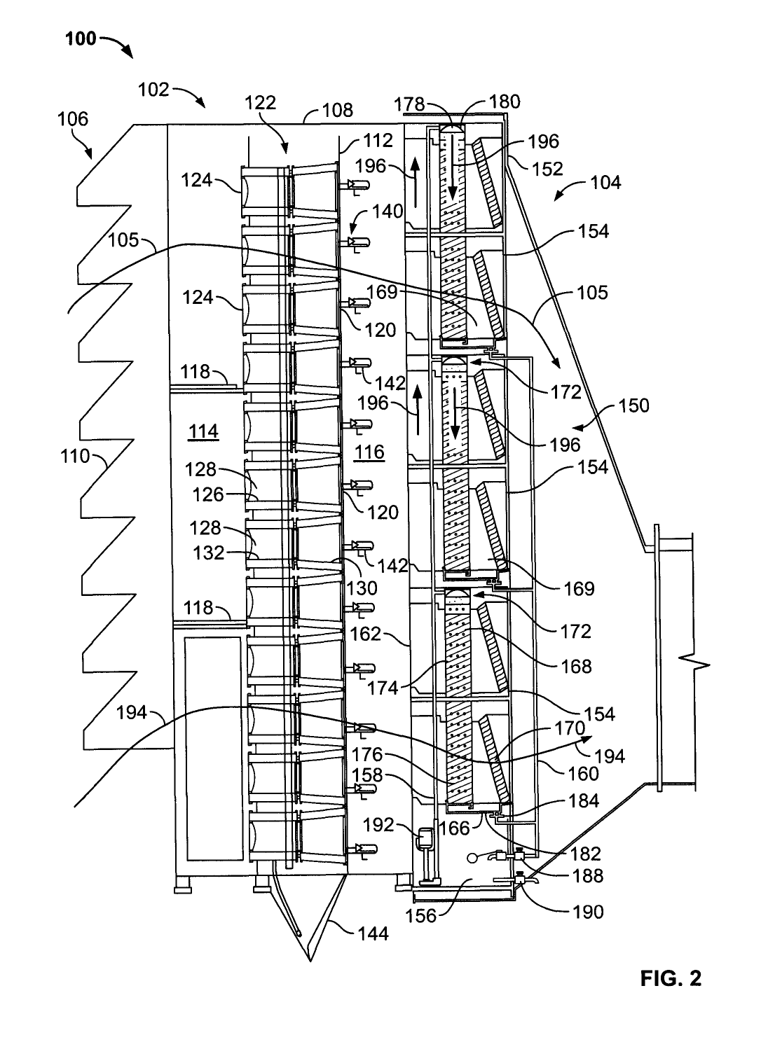

FIG. 2 is a schematic view of an exemplary inlet air treatment system 100 that may be used with the gas turbine engine system 10. Inlet air treatment system 100 includes an air filter assembly 102 that is coupled in flow communication with an evaporative cooler assembly 104, such that an airflow path 105 is defined between air filter assembly 102 and evaporative cooler assembly 104. Air filter assembly 102 includes an inlet hood assembly 106 and an air filter enclosure 108. Inlet hood assembly 106 includes a plurality of vertically-spaced inlet hoods 110. Air filter enclosure 108 includes a filter wall 112 that is positioned within air filter enclosure 108 such that an air filter chamber 114 and a clean air chamber 116 are defined therein. In the exemplary embodiment, a plurality of walkways 118 extend between filter wall 112 and air filter enclosure 108 to provide access to each inlet hood 110. A plurality of apertures 120 extend through filter wall 112 to enable flow communication between air filter chamber 114 and clean air chamber 116. A filter assembly 122 positioned within air filter chamber 114 is coupled to filter wall 112 such that filter assembly 122 is in flow communication with apertures 120. In the exemplary embodiment, filter assembly 122 includes a plurality of filter cartridges 124.

Each filter cartridge 124 is coupled to filter wall 112 such that each filter cartridge 124 encapsulates a respective aperture 120. In the exemplary embodiment, each filter cartridge 124 includes a tubular-shaped filter membrane 126 that includes a filtered air channel 128 defined therein. Moreover, in the exemplary embodiment, filter membrane 126 includes a conical portion 130 that is coupled to a cylindrical portion 132, such that filtered air channel 128 extends between conical portion 130 and cylindrical portion 132. Each filter cartridge 124 is coupled to filter wall 112 such that filtered air channel 128 is positioned in flow communication with clean air chamber 116 through aperture 120.

A compressed air pulse assembly 140 positioned within clean air chamber 116 is coupled to filter wall 112. Compressed air pulse assembly 140 includes a plurality of pulse jet air cleaners 142 that are each positioned in flow communication with filtered air channel 128 via apertures 120. During cleaning of filter cartridges 124, pulse jet air cleaner 142 channels a pulsed flow of air through filtered air channel 128 to facilitate removing dust and debris from filter membrane 126. A debris collection hopper 144 coupled in flow communication with air filter chamber 114 collects debris entering air filter chamber 114 from inlet hood assembly 106.

Evaporative cooler assembly 104 includes an evaporative cooler 150 that is positioned within an enclosure 152. In the exemplary embodiment, evaporative cooler 150 includes a plurality of vertically-stacked evaporative media modules 154 positioned within enclosure 152, a fluid reservoir 156 coupled to a fluid supply system 158, and a fluid drain system 160 coupled to fluid reservoir 156. In the exemplary embodiment, evaporative cooler 150 includes three evaporative media modules 154. Alternatively, evaporative cooler 150 may include any number of evaporative media modules 154 that enables evaporative cooler 150 to function as described herein.

Each evaporative media module 154 includes a support frame 162, a media drain assembly 166 coupled to support frame 162, a plurality of cooling media 168, a plurality of drift eliminators 170, and a fluid distribution assembly 172. Cooling media 168 is positioned within support frame 162 such that clean air chamber 116 is defined between filter assembly 122 and cooling media 168, and a cooled air chamber 169 is defined between cooling media 168 and drift eliminators 170. Cooling media 168 includes an upper media portion 174 that is coupled in flow communication with a lower media portion 176. Lower media portion 176 is coupled to media drain assembly 166 such that media drain assembly 166 retains cooling media 168 positioned within support frame 162. Drift eliminator 170 is coupled to media drain assembly 166 such that media drain assembly 166 retains drift eliminator 170 positioned within support frame 162.

In the exemplary embodiment, drift eliminator 170 is positioned downstream from cooling media. Fluid distribution assembly 172 is coupled in flow communication with cooling media 168 for channeling cooling fluid 196 to upper media portion 174. In the exemplary embodiment, fluid distribution assembly 172 includes a fluid nozzle 178 that is coupled above an upper media portion 174 of cooling media 168, and a deflector plate 180 that is positioned above fluid nozzle 178 for directing fluid downward from fluid nozzle 178 and through cooling media 168. Media drain assembly 166 includes a drain pan 182 that is coupled to a drain 184. More specifically, drain pan 182 is beneath a lower media portion 176 of cooling media 168 and drift eliminator 170 for use in collecting cooling fluid 196 channeled through cooling media 168 and drift eliminator 170. Drain 184 is coupled to fluid drain system 160 for channeling collected cooling fluid 196 to fluid reservoir 156. Fluid reservoir 156 includes a fluid return valve 188 that is coupled to fluid drain system 160, a make-up fluid system 190, and a pump 192 that is coupled to fluid supply system 158 for channeling fluid to fluid supply system 158.

During operation, inlet hood assembly 106 channels a flow of air 194 through airflow path 105 into air filter chamber 114. As air enters inlet hood assembly 106 and is directed downward towards debris collection hopper 144, at least some debris entrained within air flow 194 is gravity fed and channeled into debris collection hopper 144. Air flow 194 is then directed through filter membrane 126 and into filtered air channel 128. Filter membrane 126 facilitates removing additional dust and debris entrained by air flow 194 such that air entering filtered air channel 128 is substantially free of dust and debris. Air flow 194 is then redirected through apertures 120 towards clean air chamber 116, wherein air flow 194 is channeled to evaporative cooler 150 and through cooling media 168. Pump 192 channels cooling fluid 196 from fluid reservoir 156 to cooling media 168 through fluid supply system 158.

In the exemplary embodiment, cooling fluid 196 is channeled from fluid nozzle 178 towards deflector plate 180, wherein the cooling fluid 196 is redirected towards upper media portion 174. In an alternative embodiment, cooling fluid 196 is dispersed in a fog within cooling media 168. Cooling fluid 196 gravity fed from upper media portion 174 towards lower media portion 176, wherein the cooling fluid 196 contacts air flowing past cooling media 168. As air flow 194 contacts cooling fluid 196, at least a portion of the heat contained in air flow 194 is transferred to cooling fluid 196 through evaporative cooling, thus reducing the temperature of air flow 194. As air flows past cooling media 168, at least a portion of cooling fluid 196 is carried by air flow 194 towards drift eliminator 170 to facilitate removing cooling fluid from air flow 194 before air flow 194 is channeled towards combustor 14. A portion of cooling fluid 196 is channeled through cooling media 168 to media drain assembly 166. Cooling fluid 196 from drift eliminator 170 is channeled to media drain assembly 166. Drain pan 182 collects cooling fluid 196 channeled through cooling media 168 and drift eliminator 170, and the collected cooling fluid 196 is returned to fluid drain system 160 through common drain 184. Fluid drain system 160 channels cooling fluid 196 to fluid reservoir 156 for recirculation through fluid supply system 158.

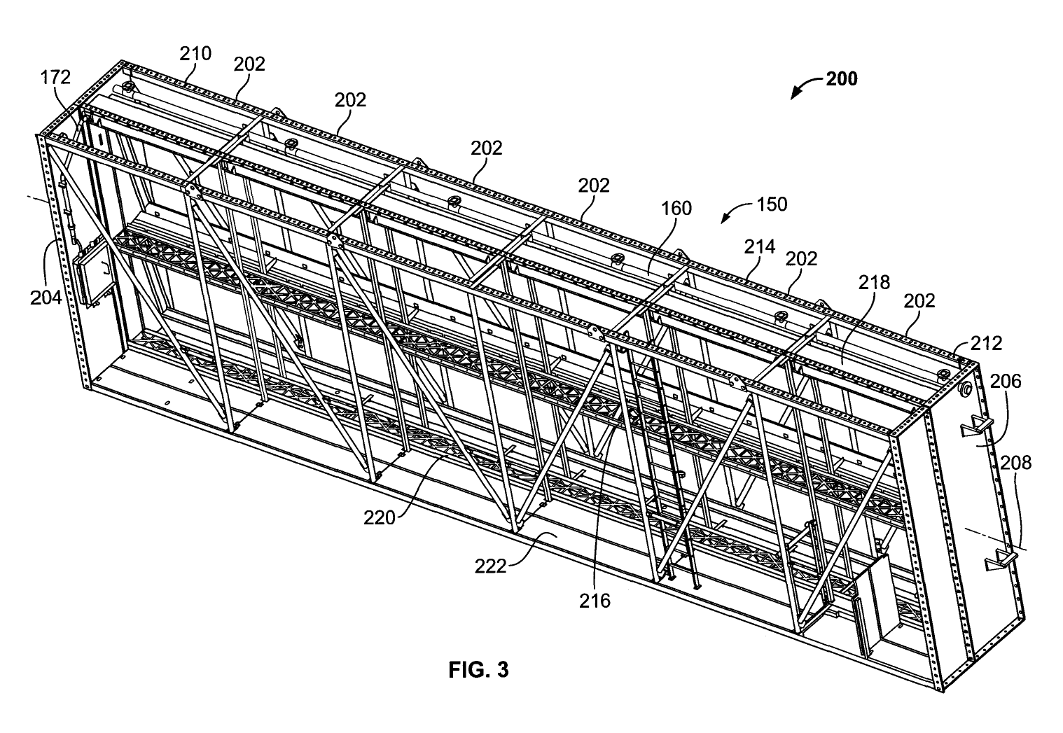

FIG. 3 is a perspective view of an exemplary evaporative media module 200 that may be used with evaporative cooler 150. Components illustrated in FIG. 2 are labeled with the same reference numbers in FIG. 3. In the exemplary embodiment, evaporative media module 200 includes a plurality of cooling sections 202 that extend between a first end wall 204 and an opposing second end wall 206. Each cooling section 202 is coupled to an adjacent cooling section 202 along a longitudinal axis 208 such that a first end cooling section 210 positioned adjacent to first end wall 204 is in flow communication with a second end cooling section 212 positioned adjacent to second end wall 206 through each adjacent cooling section 202. Each cooling section 202 includes a support frame 214 that is coupled to a middle support tray 216, to an upper support tray 218, and to a media drain assembly 220. Middle support tray 216 is positioned between upper support tray 218 and media drain assembly 220 such that upper media portion 174 (shown in FIG. 2) extends between upper support tray 218 and middle support tray 216, and such that lower media portion 176 (shown in FIG. 2) extends between middle support tray 216 and media drain assembly 220. Fluid distribution assembly 172 is coupled to upper support tray 218 for channeling cooling fluid 196 to upper media portion 174. Moreover, fluid drain system 160 is positioned adjacent to upper support tray 218 and is coupled to a vertically-adjacent evaporative media module 200. In the exemplary embodiment, a walkway 222 is coupled to support frame 214 and extends outward from media drain assembly 220 to provide access to evaporative media module 200.

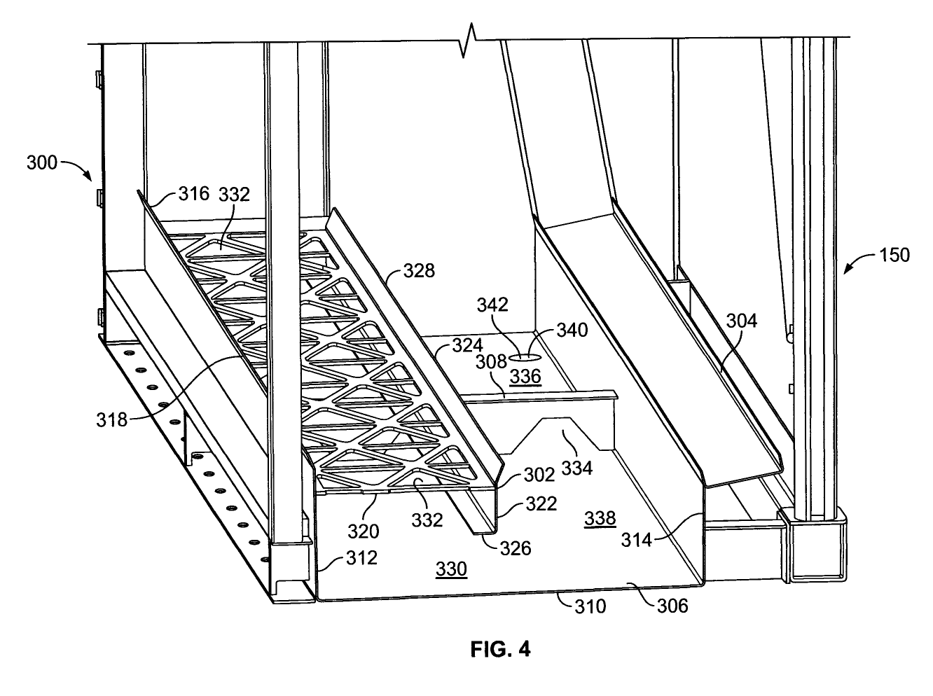

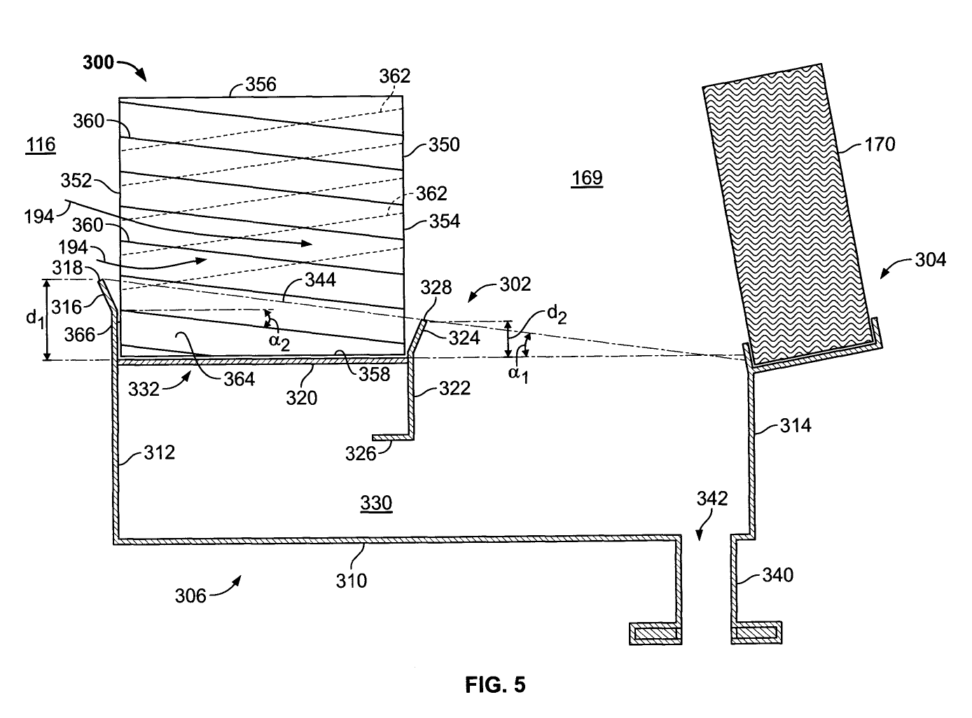

FIG. 4 is a partial perspective view of an exemplary media drain assembly 300 that may be used with evaporative cooler 150. FIG. 5 is a cross-sectional view of media drain assembly 300. Components illustrated in FIG. 3 are labeled with the same reference numbers in FIGS. 4 and 5. In the exemplary embodiment, media drain assembly 300 includes a media support assembly 302, a drift support assembly 304, a drain pan 306 and at least one support member 308. Drain pan 306 includes a lower wall 310 that extends between a front wall 312 and an opposing back wall 314. In the exemplary embodiment, front wall 312 and back wall 314 each extend outward from lower wall 310 and are substantially perpendicular to lower wall 310. Front wall 312 includes a front flange 316 that extends obliquely outward from an upper portion of front wall 312. Front flange 316 includes a tip end 318. Media support assembly 302 is coupled to front wall 312 and extends inward from front wall 312 towards back wall 314. In the exemplary embodiment, drift support assembly 304 is coupled to drain pan back wall 314 and extends outward from back wall 314. In an alternative embodiment, drift support assembly 304 extends inward from back wall 314 towards front wall 312.

Media support assembly 302 includes a media support wall 320 and a media back wall 322 coupled to media support wall 320. In the exemplary embodiment, media support wall 320 extends substantially perpendicular from media back wall 322. Media back wall 322 includes a rear flange 324 and a flange return 326. Flange 324 extends obliquely outward from media back wall 322 and includes a flange tip end 328. Media support wall 320 is coupled to drain pan front wall 312 and extends substantially perpendicularly from front wall 312, such that a continuous drainage chamber 330 is defined between front wall 312 and back wall 314. A plurality of openings 332 are defined in media support wall 320 such that openings 332 coupled cooling media 350 in flow communication with drainage chamber 330. In the exemplary embodiment, openings 332 are each triangular. In an alternative embodiment, openings 332 may have any shape that enables evaporative cooler 150 to operate as described herein.

Support member 308 is positioned within at least a portion of drain pan 306 and extends through front wall 312 and back wall 314. Support member 308 is coupled to drain pan 306 and to flange return 326 to provide support to media support assembly 302. Support member 308 includes a plurality of openings 334 that couple a first portion 336 of drainage chamber 330 in flow communication with a second portion 338 of drainage chamber 330. A drain 340 extends from lower wall 310 and is in flow communication with drainage chamber 330 through a drain opening 342 defined in lower wall 310. In the exemplary embodiment, drain 340 is positioned adjacent to drain pan back wall 314 to enable cooling fluid 196 channeled through cooling media 350 to be collected in drainage chamber 330 and channeled to drain 340.

In the exemplary embodiment, media support wall 320 is coupled to front wall 312 such that front wall 312 extends a first distance d₁ from media support wall 320. Moreover, media support wall 320 is coupled to media back wall 322 such that media back wall 322 extends a second distance d₂ from media support wall 320. Second distance d₂ is shorter than first distance d₁. In an alternative embodiment, a plane 344 extending between front flange tip end 318 and rear flange tip end 328 intersects with media support wall 320, at a phantom line 346, to form an angle α₁. In the exemplary embodiment, angle α₁ is between about 15° to about 60°.

Cooling media 350 is coupled to media support wall 320 and is positioned between front wall 312 and rear flange 324, such that media support assembly 302 retains cooling media 350 within evaporative media module 200. In the exemplary embodiment, cooling media 350 includes a front side 352, a back side 354 that is oriented substantially parallel to front side 352, an upper end 356, and a lower end 358. Ends 356 and 358 extend substantially perpendicularly between front and back sides 352 and 354, respectively. A plurality of first cooling channels 360 extend between front side 352 and back side 354, and are oriented obliquely towards lower end 358 at an angle α₂. In the exemplary embodiment, angle α₂ is between about 15° to about 60°. A plurality of second cooling channels 362 extend between front side 352 and back side 354, and are oriented obliquely towards upper end 356. During operation, air flow 194 is channeled through cooling media 350, such that air flows from front side 352 towards back side 354 via first and second cooling channels 360 and 362, respectively.

In the exemplary embodiment, cooling media 350 also includes at least one third cooling channel 364 that extends between front side 352 and lower end 358 and defines a bypass flowpath, such that air flow 194 may not pass through a full width of cooling media 350. Cooling media 350 is positioned adjacent to drain pan front wall 312 such that front wall 312 is in sealing contact with media front side 352. Media support assembly 302 is coupled to drain pan 306, such that front wall 312 extends above media lower end 358 to substantially cover a front opening 366 of third cooling channel 364, and to substantially prevent air flow from entering third cooling channel 364 and bypassing cooling media 350. Rear flange 324 extends above lower end 358, such that clean air chamber 116 is in flow communication with cooled air chamber 169 via first and second cooling channels 360 and 362 respectively.

During operation, air flow 194 enters cooling media 350 via cooling channels 360 and 362. Cooling fluid 196 cascades downward through cooling media 350 via fluid supply system 158. As air flow 194 enters cooling media 350, front wall 312 substantially prevents air flow 194 from entering the bypass flowpath defined by third cooling channel 364. More specifically, media support assembly 302 facilitates improved cooling of air flow 194 by covering third cooling channel front opening 366 to substantially prevent air flow from entering the bypass flowpath, and channeling airflow 194 through the full width of cooling media 350.

The above-described systems and methods facilitate improved cooling of a flow of intake air by substantially preventing air from bypassing a cooling media and channeling air through a full width of the cooling media. More specifically, the evaporative cooler includes a media drain assembly that covers a cooling media bypass flowpath and substantially prevents a flow of air from entering the bypass flowpath. Additionally, the media drain assembly that includes a continuous drainage chamber, such that fluid collected from the cooling media and a drift eliminator may be channeled to a common drain. As such, the cost of assembling the evaporative cooler and the cost of maintaining the gas turbine engine system is facilitated to be reduced.

Exemplary embodiments of systems and methods for assembling an evaporative cooler are described above in detail. The systems and methods are not limited to the specific embodiments described herein, but rather, components of systems and/or steps of the method may be utilized independently and separately from other components and/or steps described herein. For example, the systems and method may also be used in combination with other air treatment systems and methods, and are not limited to practice with only the gas turbine engine system as described herein. Rather, the exemplary embodiment can be implemented and utilized in connection with many other air treatment system applications.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method of assembling an evaporative cooler for use with a turbine engine system, said method comprising:
coupling a drain pan to a support frame, wherein the drain pan includes a front wall and a back wall; and
coupling a media support assembly to the drain pan to form the evaporative cooler, wherein the media support assembly includes a media support wall and a rear flange, the media support wall extends substantially perpendicularly from the drain pan front wall and defines a continuous drainage chamber between the drain pan front wall and the back wall.

2. A method in accordance with claim 1 further comprising coupling a cooling media to the media support assembly, such that the drain pan front wall at least partially covers the cooling media to substantially prevent air entering the evaporative cooler from bypassing the cooling media.

3. A method in accordance with claim 1 further comprising coupling a drift eliminator support to the drain pan back wall such that the drift eliminator support extends outward from the back wall of the drain pan.

4. A method in accordance with claim 1 further comprising extending a drain from the drain pan to the drainage chamber, such that the drain is adjacent to the drain pan back wall.

5. An evaporative cooler assembly for use with a turbine engine system, said evaporative cooler assembly comprising:
a drain pan comprising a front wall and a back wall opposite said front wall; and
a media support assembly comprising a media support wall and a rear flange, said media support assembly extending substantially perpendicularly from said front wall such that a continuous drainage chamber is defined between said drain pan front wall and said drain pan back wall.

6. An evaporative cooler assembly in accordance with claim 5, wherein said front wall extends a first distance from said support wall, said rear flange extends a second distance from said support wall that is shorter than the first distance.

7. An evaporative cooler assembly in accordance with claim 5, wherein said front wall comprises a tip end, said rear flange comprises a tip end, said rear flange oriented such that a plane extending between said front wall tip end and said rear flange tip end forms an angle with said media support wall that is between about 15 degrees and about 60 degrees.

8. An evaporative cooler assembly in accordance with claim 5 further comprising a cooling media positioned within said media support assembly, said cooling media comprises a plurality of cooling channels defined therein, said front wall at least partially covers said plurality of cooling channels to substantially prevent a flow of air entering said evaporative cooler assembly from bypassing said cooling media.

9. An evaporative cooler assembly in accordance with claim 5 further comprising a drain extending from said drain pan to said drainage chamber.

10. An evaporative cooler assembly in accordance with claim 9, wherein said drain is adjacent to said drain pan back wall.

11. An evaporative cooler assembly in accordance with claim 5 further comprising a drift eliminator support coupled to said drain pan back wall and extending outward from said back wall.

12. An evaporative cooler assembly in accordance with claim 5, wherein said media support assembly support wall comprises a plurality of openings extending through said support wall, each of said plurality of openings is and in flow communication with said drainage chamber.

13. An evaporative cooler assembly in accordance with claim 5 further comprising at least one support member coupled to said media support assembly for supporting said media support assembly, said support member is within at least a portion of said drain pan.

14. A gas turbine engine system comprising:
a compressor;
a combustor in flow communication with and downstream from said compressor; and
an evaporative cooler assembly coupled to said compressor, said evaporative cooler assembly comprising:
a drain pan comprising a front wall and a back wall opposite said front wall; and
a media support assembly comprising a media support wall and a rear flange, said media support assembly extending substantially perpendicularly from said front wall such that a continuous drainage chamber is defined between said drain pan front wall and said drain pan back wall.

15. A gas turbine engine system in accordance with claim 14, wherein said front wall extends a first distance from said support wall, said rear flange extends a second distance from said support wall that is shorter than the first distance.

16. A gas turbine engine system in accordance with claim 14, wherein said evaporative cooler assembly further comprises a cooling media positioned within said media support assembly, said front wall at least partially covers said cooling media to substantially prevent a flow of air entering said evaporative cooler assembly from bypassing said cooling media.

17. A gas turbine engine system in accordance with claim 14, wherein said evaporative cooler assembly further comprises a drain extending from said drain pan to said drainage chamber, wherein said drain is adjacent to said drain pan back wall.

18. A gas turbine engine system in accordance with claim 14, wherein said evaporative cooler assembly further comprises a drift eliminator support coupled to said drain pan back wall such that said drift eliminator support extends outward from said back wall.

19. A gas turbine engine system in accordance with claim 14, wherein said media support assembly support wall comprises a plurality of openings extending through said support wall, each of said plurality of openings is in flow communication with said drainage chamber.

20. A gas turbine engine system in accordance with claim 14, wherein said evaporative cooler further comprises a support member coupled to said media support tray, said support member positioned within at least a portion of said drain pan.
